(19) United States
(12) Patent Application Publication
(10) Pub. No.: US 2025/0262941 A1
(43) Pub. Date: Aug. 21, 2025

(54) Individual Monitoring Of A Plurality Of Output Points Of A System For The Vehicle-Based Supply Of External Loads

(71) Applicant: Schaeffler Technologies AG & Co. KG, Hersogenaurach (DE)

(72) Inventor: Franz Pfeilschifter, Walderbach (DE)

(73) Assignee: Schaeffler Technologies AG & Co. KG, Herzogenaurach (DE)

(21) Appl. No.: 19/176,759

(22) Filed: Apr. 11, 2025

Related U.S. Application Data
(63) Continuation of application No. PCT/EP2023/078063, filed on Oct. 10, 2023.

(30) Foreign Application Priority Data
Oct. 14, 2022 (DE) 10 2022 210 856.6

(51) Int. Cl. B60L 1/00; B60L 3/04; B60L 55/00; H02J 7/00

(52) U.S. Cl. CPC B60L 1/006; B60L 3/04; B60L 55/00; H02J 7/00304; H02J 7/0063; B60L 2210/30; B60L 2210/40; H02J 2207/20

(57) ABSTRACT

A method for monitoring at least one first and one second alternating-current output point in a vehicle is provided. The method includes detecting a total alternating current outputted by an inverter via a distribution point to the output points as a whole and also detecting at least one first alternating current, which flows in the first output point. The method includes determining a second alternating current, which flows in the second output point, as the difference between the total alternating current and the at least one first alternating current. The method includes comparing the at least one first alternating current and the second alternating current with a respective threshold value. The method also includes outputting an overload signal if at least one of the comparisons shows that the threshold value is exceeded. Furthermore, a vehicle-based unit and a vehicle charging circuit for carrying out the method are described.

### CROSS-REFERENCE TO RELATED APPLICATIONS

This application claims the benefit of PCT Application PCT/EP2023/078063, filed Oct. 10, 2023, which claims priority to German Application 10 2022 210 856.6, filed Oct. 14, 2022. The disclosures of the above applications are incorporated herein by reference.

### TECHNICAL FIELD

The disclosure relates to an individual monitoring of a plurality of output points of a system for a vehicle-based supply of external loads.

### BACKGROUND

It is known to equip vehicles with an on-board electrical system which, in addition to a high-voltage rechargeable battery, also has an electric drive. Furthermore, it is known practice as an additional function to also make the energy of the rechargeable battery accessible for external loads, where this is referred to as “Vehicle to Load (V2L)”.

### SUMMARY

Conventional output points are used for this, which are designed for example in the form of conventional household outlets. As the high-voltage rechargeable battery has a very high power, considerably higher than the usual power a household outlet is designed to comply with, the disclosure provides supplying of external loads to be implemented in a safe manner.

In some implementations, the disclosure provides a method for individually monitoring a plurality of output points (for example outlets) which are connected via a distribution point to an inverter. Although the total alternating current may be in the rated range, for example of up to 32 amperes, one of the output points can nonetheless be overloaded if the load connected to it receives more than the permissible current intensity. It is therefore proposed not only to consider the total alternating current, which is usually known, but rather also to detect an alternating current of a first output point. The second alternating current at the second output point can then be ascertained as the difference between the total alternating current and the first alternating current. Both the detected first alternating current and the ascertained second alternating current are compared with a threshold value, for example with a maximum current intensity (for example 16 amperes) in order to then output an overload signal if at least one of these threshold values is exceeded by the respective alternating current. Thus, it is not the measurement of both output points that is necessary for monitoring, but rather only the detection of a first alternating current at a first output point, while the second alternating current can be calculated from the first alternating current (measured) and the total alternating current (likewise measured). The first alternating current is detected in the sense of a measurement or in the sense of a derivation of a value from a measurement, where this is also true for the total alternating current. The second alternating current is merely calculated and not measured, so this is merely ascertained as the difference between total alternating current and the first alternating current. If there are more than two output points, namely n output points, then the alternating current of n−1 output points is measured and the alternating current of the remaining output point is ascertained by way of the difference of the total alternating current and the sum of the measured alternating currents. The ascertained difference therefore results from the total alternating current and the sum of all measured alternating currents. Alternatively, the inverter may include the distribution point, where this combination can be provided as vehicle charging circuit. The inverter can in this case be a power circuit that operates in a charging mode as (controlled) rectifier.

A method is described for monitoring at least one first and one second alternating-current output point in a vehicle. The alternating-current output points are fitted in the vehicle and accessible for the contacting of external loads. Thus, an electric tool can for example be operated by way of the energy stored in the vehicle. A total alternating current is detected, such as by measurement. The total alternating current is output by an inverter via a distribution point to the output points. Starting from the inverter, the power is therefore distributed via the distribution point in the form of a plurality of power paths which lead to an output point in each case.

The inverter is fed from the rechargeable traction battery of the vehicle. The inverter may be a high-voltage inverter and configured for operating voltages of more than 60 volts, such as of 200, 400 or 800 volts. The inverter can be realized by way of a charging circuit of the vehicle or else by way of a traction inverter of the vehicle. As components of this type include controllable semiconductor switches, a corresponding inverter can be realized by actuating these switches. The total alternating current is detected by way of a measuring device in the inverter, such as in the alternating current side of the inverter, or else on the direct current side of the inverter, where this value must then be converted by way of a factor in order to obtain the total alternating current. Furthermore, at least one first alternating current is detected, which flows in the first output point. The at least one first alternating current is measured, for example by way of a further measuring device. A suitable measuring device is Hall elements that are configured as current sensors or else shunt resistors. At the Hall element or at the shunt, a signal is generated, from which the flowing current can be derived. In addition, measurement transformers or other inductive couplings to the conductor of the relevant alternating current are also conceivable for this purpose. If a plurality of first alternating currents exist, these are detected or measured in each case. The aforementioned devices can be used for this.

The second alternating current does not have to be measured, but rather is ascertained, by calculation, as the difference between the total alternating current and the at least one first alternating current. If a plurality of first alternating currents are provided, the second alternating current is the difference between the total alternating current and all first alternating currents (i.e. between the second alternating current and the sum of all first alternating currents). The ascertainment can also take place analogously by way of a subtraction circuit. The second alternating current is that which flows to the second output point. The (at least one) first alternating current flows from the distributor point to first output point and the second alternating current flows from the distributor point to the second output point. If a plurality of first alternating currents are provided, then a plurality of first output points are also provided and vice versa. The first alternating currents flow to the respective first output points. If further output points are provided, then the alternating current of the further output points also flows from the distributor point to the relevant output point. The second current results as the difference between the total alternating current and the first alternating current (or all measured-first-alternating currents). If there is a further consumer in the on-board electrical system, then its current consumption can be subtracted or added to the difference in order thus to obtain the pure difference between total alternating current and all measured alternating currents.

The first alternating current is compared with an associated threshold value and the second alternating current is likewise compared with an associated threshold value. The two threshold values may be equal, if the output points are configured according to the same output power or according to the same current intensity. An overload signal is output if all comparisons or even only one of the comparisons or else a subset thereof show that the threshold value is exceeded. Thus, if at least one comparison shows that the respective threshold value has exceeded the respective threshold value, the overload signal is output. The overload signal can be output specifically for the relevant output point for which the alternating current is above the associated threshold value. The overload signal can also be output in a debounced manner, that is to say that the exceeding of the threshold value must continue for a minimum duration in order to trigger the overload signal.

The method relates to at least one alternating-current output point and one second alternating-current output point, which are supplied from the same distribution point. The first alternating-current output points, if a plurality of them are present, are measured, that is to say the associated first alternating currents of the first alternating-current output points are detected (by measurement for example). The second alternating current is ascertained from the difference between the total alternating current and the sum of all first (measured) alternating currents. The alternating-current output points are also referred to as output points for short here.

In some examples, the first alternating current is detected using a current sensor which is arranged in a first plug-in device which is connected to the distribution point. This connection may be plug-connection-free. Alternatively or additionally, the first alternating current can be detected using a current sensor which is provided in a second plug-in device. This second plug-in device is plugged into the first plug-in device, where the first plug-in device is connected to the distribution point (plug-connection-free). In other words, the current sensor can be located in the first plug-in device, which is designed for example as a power outlet or female connector, or can be provided in a plug-in device that is plugged in it, for example a load connector or an adapter into which a load connector can be plugged.

Alternatively or in combination with this, the first alternating current can be detected using a current sensor which is provided in an intermediate adapter. The intermediate adapter is plugged in the first plug-in device which is connected (plug-connection-free) to the distribution point. A second plug-in device can be plugged into the intermediate adapter here, so that the intermediate adapter connects the first and the second plug-in device to one another. The intermediate adapter can therefore have a connection in the form of a socket outlet (female connector) or outlet, into which the second plug-in device (that is to say the load connector for example) is plugged.

The current sensor can therefore be provided in a plug-in device that is designed in accordance with a conventional household outlet. The current sensor can also be integrated into a load connector which is designed for plugging into a household outlet of this type. Finally, an intermediate adapter can be provided, which has a female connector in the form of a conventional household outlet, into which a load connector (for example a second plug-in device) can be plugged. The current sensors are in each case arranged in such a manner that these current sensors can detect the current flowing through the respective device or current flowing through the intermediate adapter.

The outlets referred to here as outlet or as a (conventional) household outlet are outlets which are designed in compliance with the standard NEMA 1-15, 5-15, 14-50R or 14-30R or else are designed to accommodate a plug according to the type CEE7/16 (Europlug) or else are designed to accommodate a plug according to CEE7/14, CEE7/5, CEE7/4 or CEE7/7. Further possible examples are outlets for accommodating plugs of type BS1363, SI-32, AS3112, SEV1011, DS60884-2-D1, CEI23-50, BS546, IEC60506-7 or else female connectors for cold device plugs (IEC60320C13, 14, 19 or similar). In some examples, conventional household outlets are designed according to a standard that is customary for the country. Single-phase alternating-current outlets which can be designed with or without grounding contact are referred to as household outlets. Household outlets are effectively designed for an AC voltage of at least 100 volts, for example for voltages of 230 volts at 50 hertz.

The at least one alternating current is transmitted at an evaluation unit. In this case, a signal is transmitted, which reproduces the level of the alternating current. The effective current intensity, the current amplitude or else the peak-to-peak current intensity is referred to as the level of the alternating current. The signal can be transmitted in a wired or wireless manner, on a direct path or via an entity which changes the transmission protocol. In some examples, the at least one alternating current or the signal reproducing this alternating current can be transmitted by a CAN bus, by way of an IP-based network or by way of a different data transmission protocol. The signal can also be transmitted wirelessly, for example by way of a Wi-Fi signal or by way of a Bluetooth signal or in accordance with a different wireless signal with standardized protocol.

In some examples, the inverter is designed as a bidirectional charging power converter of the vehicle. In other words, the inverter can be designed as an alternating-current charging circuit, which is bidirectional however and can convert direct current (for example from a rechargeable traction battery of the vehicle) into alternating current. Here, the charging power converter or the inverter is designed to output a power signal with a desired nominal voltage (for example 110, 120, 200, 220 or 230 volts) and in accordance with a desired frequency (for example 50, 60 or 100 hertz) as total alternating current. In some examples, the inverter is designed to output a sinusoidal current as total alternating current. The inverter is designed to generate the total alternating current by inverting a direct current that is supplied from a direct-current source. The total alternating current can be supplied from a DC voltage source, for example a rechargeable battery such as a high-voltage rechargeable battery, in order to generate the total alternating current by inversion. In the case of directional alignment of the charging power converter, this charging power converter may have a lower output into the function of the inverter than in the opposite direction, in which this charging power converter operates as a rectifier.

The total alternating current is generated by the inverter by inverting the direct current or the DC voltage, which direct current or which DC voltage is output from a rechargeable traction battery. The rechargeable traction battery forms the direct-current source in that case. If the charging power converter is operated in the opposite direction, then the charging power converter is used as a rectifier and for supplying charging current to the rechargeable traction battery.

In some implementations, a charging control unit is provided, which actuates the inverter and which is set up to operate the inverter bidirectionally. For example, the charging control unit is set up to operate the inverter for inversion and also for rectification (to operate it in the opposite direction).

The sensor for detecting the first alternating current can be provided in an adapter which is connected to a connection point. The adapter itself forms a connection point for external loads. The detected alternating current is transmitted from the adapter to the charging control unit, for example from a transmission unit of the adapter. The first output point itself may have the current sensor, where an adapter is plugged into this output point. The adapter offers a plug-in device in this case, for example a female connector, into which an external load can be plugged. The plug connection between adapter and output point (with current sensor) can be proprietary and differ from all standardized power outlets and can further have a standardized interface for the plugging-in of conventional load connectors. The adapter can have a transmission device which is set up to transmit a value (which represents the intensity of the alternating current that is flowing through the adapter) that is detected by the sensor for example to a distribution point, a charging control unit, vehicle-based unit or to an evaluation unit, as are described here.

A distribution point can be provided, in which not only is the total alternating current divided into the first and second alternating currents, but rather in which a current sensor is also provided for detecting the at least one first alternating current. A distribution point of this type can be connected in a data-transmitting manner to a charging control unit which actuates the inverter. In general, the charging control unit can also be designed as a control device which has an evaluation unit as is described here.

A vehicle-based unit is described, which is designed for carrying out the method. The vehicle-based unit is used for feeding vehicle-external loads by way of a vehicle-based energy store. In some examples, the vehicle-based unit is designed for controlling this feed. The vehicle-based unit has an evaluation unit which has a total-current measuring input and at least one individual-current measuring input. The evaluation unit further has an output for outputting an overload signal. The evaluation unit has a subtraction element which is set up to form the difference of the current value that is applied at the total-current measuring input (that is to say the total alternating current) and the at least one current value that is applied to the at least one individual-current measuring input (corresponding to the at least one alternating current). Furthermore, a comparator is provided there, which compares the at least one current value at the at least one individual-current measuring input and the difference with an associated threshold value. The comparator is designed to output an overload signal if at least one of the comparisons shows that the respective threshold value is exceeded. A unit of this type can be provided in the charging control unit or can be connected upstream of the same. A suitable vehicle-based unit is also an intermediate adapter as is described here. As this intermediate adapter is connected to the on-board electrical system of the vehicle, it is considered as vehicle-based here.

In some implementations, a charging circuit control unit is connected in an actuating manner to the inverter and is set up to actuate this inverter for controlled rectification (for example in accordance with a desired voltage or a desired current on the DC voltage side). In addition, the charging control unit may be designed to operate the circuit as an inverter in order thus to transmit power in the opposite direction. If the charging control unit includes a vehicle-based unit or if a corresponding unit is connected downstream, then provision can be made for the charging control unit to reduce the power or switch off the inverter if at least one of the threshold values within the vehicle-based unit is exceeded. A device described here as a vehicle-based unit is a device that is set up to be accommodated in a vehicle, such as in an on-board electrical system controller or in an on-board electrical system. The unit is used to feed vehicle-external loads to the effect that this is designed for actuating the inverter or for monitoring the current which is output by the inverter (including the individual currents at the output points). In some examples, in addition to loads that are connected to one of the output points, vehicle-internal consumers can be connected to the inverter in order to be operated by the same using alternating current. In this case, its current is also measured and taken into consideration as additional load within the monitoring, such as a load that is added to the total alternating current that is carried via the distribution point. As a result, an overload can be monitored by an internal load together with an external load.

The method can also be implemented in a vehicle charging circuit, for example in a bidirectional vehicle charging circuit. A vehicle charging circuit of this type has a controlled rectifier which in a charging state of the circuit, for example in an alternating-current charging state, rectifies a charging alternating current in order to output the rectified current to a direct-current connection of the charging circuit (and possibly a battery that is connected thereto). This rectifier operates in a feedback state of the circuit as an inverter, such as an inverter as described here. The rectifier operates in the feedback state as an inverter which, starting from the DC voltage at the direct-current connection, generates an alternating current at an alternating-current connection or on an alternating-current side of the rectifier (at corresponding phase potentials of the circuit). A distribution point is connected to the alternating-current side of the rectifier. Starting from the alternating-current side of the rectifier this leads first to at least one first alternating-current connection and to a second alternating-current connection. The distribution point connects these connections to the rectifier. Alternating-current output points can be connected to the first and to the second alternating-current connection; for example, a vehicle charging connection can be connected to one of the alternating-current connections. The connections are designed to this end, with regard to the configuration of the current carrying capacity (which should be dimensioned to be higher in the case of connection to a vehicle charging connection than in the case of connection to an alternating-current output point). A first current sensor ascertains the total alternating current between rectifier (which is operated as inverter) and the distribution point. At least one second current sensor ascertains the at least one first alternating current, which flows from the distribution point to the at least one first alternating-current connection. A differential element of the circuit ascertains the alternating current which flows from the distribution point to the second alternating-current connection as the difference between the total alternating current and the first alternating current (or the sum of all first, measured alternating currents). A comparator of the circuit compares the at least one first (measured) alternating current with an associated threshold value. The comparison likewise compares the second (ascertained) alternating current with an associated threshold value. If one of the threshold values is exceeded, then the circuit is set up to output an overload signal at a (signal) output of the circuit. The comparator can additionally be set up also to compare the total current with an associated threshold value in order to output an overload signal (such as at the output) if the threshold value is exceeded.

The threshold value for the alternating current that flows between the distribution point and the vehicle charging connection may be larger than the threshold value for the alternating current that flows between the distribution point and one of the alternating-current output points. As a result, it is taken into consideration that the maximum current that can be fed back into a supply system via the vehicle charging connection is larger in some examples than the maximum current that can be output via an alternating-current output point.

In some implementations, the vehicle charging circuit is an alternating-current charging circuit. The vehicle charging circuit is designed for bidirectional power conversion. The vehicle charging connection refers to a connection that is set up for the (AC) charging of a vehicle. With the circuit described here, this connection is also used for feedback. The constituent phrase “vehicle charging” should therefore not limit its function and configuration to the charging, but rather merely defines the suitability for charging in addition to the suitability for feeding back. The vehicle charging connection can also be referred to as a vehicle connection or vehicle charging and feedback connection.

The details of set forth in one or more implementations of the disclosure are set forth in the accompanying drawings and the description below. Other aspects, features, and advantages will be apparent from the description and drawings, and from the claims.

### DESCRIPTION OF DRAWINGS

FIG. 1 serves to explain the methods and apparatuses described here in more detail.

Like reference symbols in the various drawings indicate like elements.

### DETAILED DESCRIPTION

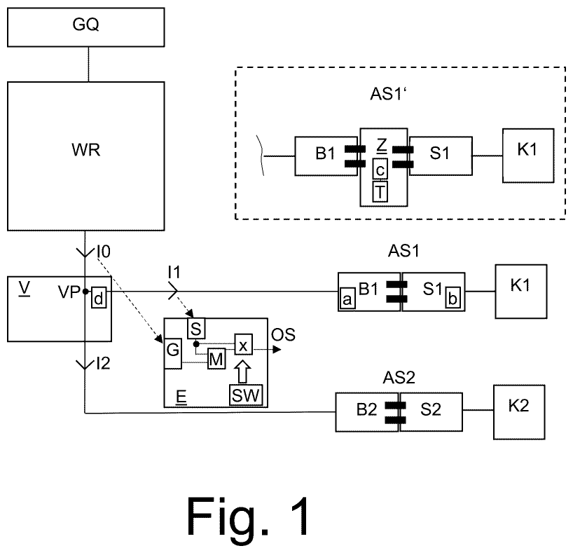

FIG. 1 shows an inverter WR and a DC voltage source GQ. The total alternating current I0 output by the inverter is carried to a distributor point VP of a distribution point V. At this distributor point VP or inside the distribution point, the power path is divided and a first alternating current I1 and a second alternating current 12 are produced. These are carried to a first output point AS1 (current I1) or to a second output point AS2 (current I2). Loads K1 and K2 are connected to this output point. Here, the first current is carried from the distributor point V to a first female connector or plug-in device B1. A second plug-in device S1 is plugged into this. The second plug-in device is designed in a complementary manner to the first plug-in device. The second plug-in device S1 can be a plug. This can lead to a line which is in turn connected to the component K1. The second plug-in device S1 can therefore be the plug-in device belonging to the load K1. In some examples, the first plug-in device is designed in accordance with a conventional household outlet. Also, the second output point AS2 has a comparable construct with a first plug-in device B2 and a second plug-in device S2 which is plugged into the first plug-in device B2. The second component K2 can represent a consumer, the plug of which (second plug-in device S2) is plugged into the plug-in device B2.

In some implementations, only the first plug-in device B1, B2 is part of the output point and therefore part of the vehicle on-board electrical system. The second plug-in devices S1, S2 are then external plug-in elements of external loads.

In some examples, the current sensor is arranged in the first plug-in device B1 in accordance with the reference sign a, in order to detect the current flowing through this plug-in device B1 as first alternating current. Alternatively, the current sensor can be arranged as illustrated with the reference sign b. In this case, the current sensor b is in the second plug-in device. At least the current sensor b, if not additionally also the second plug-in device, may be counted as part of the first output device ASI and thus as part of the vehicle on-board electrical system. Thus, the current sensor can either be provided in the first or in the second plug-in device of the output point. One further possibility is illustrated in the upper right corner in the dashed box. An alternative first output point AS1′ is illustrated there. This has a first plug-in device B1. An intermediate adapter Z is plugged into this. The second plug-in device S2 (which leads to load K1) is then plugged in turn into the intermediate adapter Z, so that the intermediate adapter Z connects the elements B1 and S1. In the illustrated example, the current sensor c is provided in the intermediate adapter. The intermediate adapter Z can have a transmission device T that is set up to transmit the current values detected by the current sensor c to the unit E. If the intermediate adapter Z is for example connected to plug-in device B1, then the intermediate adapter Z can thus transmit the measured current values Il to the unit E by way of the transmission device T. In some examples, the sensor c is to this end connected in a signal-transmitting manner to the transmission device T. The transmission device T can be set up for wired or for wireless data transmission. To receive the current values that are sent by the transmission device T, the unit E may have a receiver which can be connected upstream of the input S or which forms the input S. The receiver is set up for receiving signals according to a data transmission protocol which is also used by the transmission device T for data transmission.

In some implementations, the current sensor is accommodated in the distribution point V, as illustrated with the reference sign d. There, the current sensor is provided in a power path or coupled to the same in a current-detecting manner. The power path leads from the connection point VP of the distribution point V to the first plug-in device or to the first output point AS1.

The inverter is set up to ascertain the total alternating current I0 either by measurement or by calculation on the basis of current operation. It is provided to ascertain the current I2 by forming the difference of I0 and the measured current I1. Both the current I1 and the current I2 is compared with a respective threshold value which for example corresponds to the nominal current or the maximum current of the connected output point. These can also be the same and for example be 16 amperes. If also only one of these values is above the respective threshold value, then an overload signal US is output. This may lead to a controller of the inverter WR deactivating the same or at least reducing the power thereof. In some examples, it may also be provided that the output point via which the alternating current which exceeds the threshold value flows is disconnected. To this end, a switch can be provided which is for example connected downstream of a vehicle-based unit.

In some implementations, a vehicle-based unit is provided for feeding vehicle-internal loads. This can be designed as a pure controller which, to illustrate this function, can be connected to an inverter in an actuating manner or can also be provided as a power unit which includes the inverter. In some examples, an evaluation unit E can be provided which can detect both the total alternating current I0 and the at least one alternating current I1. To this end, this has inputs in the form of the total-current measuring input G for the total alternating current and also at least one individual-current measuring input S for detecting the current I1 (first alternating current). The corresponding data-transmitting connection is illustrated dashed in a symbolic manner. The unit E can be part of the inverter WR or an actuation of the inverter WR. The unit further has a subtraction element M which receives the relevant values from the individual-current measuring input S and the total-current measuring input G in order to subtract these values from one another. The resulting difference is input in a comparator x. This comparator x compares the difference which corresponds to the current I2 with an associated threshold value. In addition, the individual-current measuring input S is also connected to the comparator x, so that the comparator x can also compare the current I2 (receipt via the individual-current measuring input S) with an associated threshold value. The comparator x is set up to output an overload signal OS if at least one of the threshold values is exceeded. To this end, the comparator can provide a current-individual output interface which indicates that at least one threshold value has been exceeded and additionally indicates which of the currents (I1 or I2) exceeds the threshold value, in order thus for example to switch off the relevant output point by way of a controller which is not illustrated. In some examples, the comparator x is also designed to compare the total-current measuring input or the current I2 with a relevant (higher) threshold value in order also to be able to detect an overload of the inverter WR. However, this possibility is only provided as such in certain examples, while different examples do not provide a comparison of the total alternating current I0 with an associated threshold value.

At least one internal alternating-current outlet can be provided in the vehicle or in the vehicle on-board electrical system. This alternating-current outlet corresponds to one of the output points. A plurality of output points of this type can also be provided. The sum current, that is to say the sum of the alternating currents which flow through the relevant output points, can be measured centrally using only one current sensor, such as a current sensor which is provided by the distribution point V. The supply line to all the output points can be provided with the same line cross section, for example configured for a particular nominal or maximum current intensity. This may be 10 amperes for example. If the supply lines which lead to the output points are all configured in the same manner (for example with regard to the current carrying capacity), then the threshold values or the relevant output points or plug-in elements can also be configured for the same current intensity.

In some examples, an intermediate adapter can be provided, which bears not only the current sensor, but also a transmission unit for outputting the measured current. In this manner, an output point that is connected thereto can then be authorized to output currents which are only limited by the methods described here, but not by a fuse or similar. In other words, an output point of this type can be fused with a higher current intensity than shown by the associated threshold value.

An on-board electrical system can be provided, which includes an inverter of this type, which has a DC voltage input for connection to a rechargeable battery. Furthermore, an on-board electrical system of this type has the components described here, such as the output points AS1, AS2 and the distribution point V. An on-board electrical system of this type can also be equipped with a vehicle-based unit as is described here and/or with an evaluation unit E, as is described here. The unit can further be provided in the intermediate adapter. In other words, the intermediate adapter can be equipped with the unit or is equipped with the subtraction element M, with the comparator x, the total-current measuring input G and/or the individual-current measuring input S.

If the distribution point and the inverter are integrated in a common circuit (for example a vehicle charging circuit), then a first sensor detects the current I0 and a second sensor d detects the alternating current I1. The alternating current I2 can then also be calculated as the difference. The thus measured and calculated currents I1, I2 can then be compared with a threshold value and an overload signal OS can be output if at least one of the threshold values is exceeded. In some examples, the common circuit to have a first alternating-current connection, to which a vehicle charging connection is connected, and a second alternating-current connection to which an alternating-current output point is connected. The vehicle charging connection can also be used in order to feed back alternating current to an external AC power system. The checking by way of the threshold values allows the individual monitoring of currents which flow to the vehicle charging connection and the alternating-current output point in the sense that when an associated threshold value is exceeded, an overload signal is output.

A number of implementations have been described. Nevertheless, it will be understood that various modifications may be made without departing from the spirit and scope of the disclosure. Accordingly, other implementations are within the scope of the following claims.

What is claimed is:

1. A method for monitoring at least one first and one second alternating-current output point in a vehicle, the method comprising:
detecting a total alternating current that is output by an inverter via a distribution point to a first and second output points as a whole;
detecting at least one first alternating current, which flows in the first output point;
determining a second alternating current, which flows in the second output point, as a difference between the total alternating current and the at least one first alternating current;
comparing the at least one first alternating current and the second alternating current with a respective threshold value; and
outputting an overload signal if at least one of the comparisons shows that a threshold value is exceeded.

2. The method of claim 1, wherein the first alternating current is detected using a current sensor which is arranged in a first plug-in device which is connected to the distribution point or the first alternating current is detected using a current sensor which is provided in a second plug-in device which is plugged into the first plug-in device which is connected to the distribution point.

3. The method of claim 1, wherein the first alternating current is detected using a current sensor which is provided in an intermediate adapter which is plugged into a first plug-in device which is connected to the distribution point and into which a second plug-in device is plugged.

4. The method of claim 1, wherein the first alternating current is detected using a current sensor which is provided in the distribution point in a power path which leads from a connecting point of the distribution point to a first plug-in device.

5. The method of claim 1, wherein the first alternating current is transmitted to an evaluation unit as a signal which reproduces a level of the alternating current, the signal is transmitted in a wired or wireless manner.

6. The method of claim 1, wherein the inverter is a bidirectional charging power converter of the vehicle, the total alternating current is generated by the inverter by inverting a direct current of a direct-current source.

7. The method of claim 6, wherein the total alternating current is generated by the inverter by inverting the direct current which is output by a rechargeable traction battery which is operated as direct-current source.

8. A vehicle-based unit for feeding vehicle-external loads by way of a vehicle-based energy store, the vehicle-based unit comprising:
an evaluation unit including:
a total-current measuring input,
at least one individual-current measuring input,
an output for outputting an overload signal,
a subtraction element set up to form a difference from a current value applied at the total-current measuring input by a current value applied at the individual-current measuring input, and
a comparator configured to:
compare the current value applied at the individual-current measuring input and the difference with a respective threshold value, and
output an overload signal if at least one of the comparisons shows that the respective threshold value is exceeded.

9. A vehicle charging circuit comprising:
a controlled rectifier configured to be bidirectional and having at least one first and one second alternating-current output connection, wherein one of these connections is set up to be connected to an alternating-current output point and a further one of these connections is set up to be connected to a vehicle-charging connection or a further alternating-current output point;
a distribution point connected to the rectifier and connects the rectifier to the alternating-current output point and to the vehicle charging connection or to the further alternating-current output point,
a first current sensor set up to detect a total alternating current which flows between the rectifier and the distribution point;
a second current sensor set up to detect a first alternating current which flows between the distribution point and the first alternating-current output connection or which flows between the distribution point and the vehicle charging circuit or the second alternating-current output connection;
a differential element set up to ascertain a second alternating current as difference between the total alternating current and the first alternating current; and
a comparator configured to:
compare the first and the second alternating current with a respective threshold value, and
output an overload signal at a signal output of the vehicle charging circuit if at least one of the comparisons shows that the respective threshold value is exceeded.

10. The vehicle charging circuit of claim 9, wherein the threshold value for the alternating current that flows between the distribution point and the vehicle charging connection is larger than the threshold value for the alternating current that flows between the distribution point and one of the alternating-current output points.
